(19) United States
(12) Patent Application Publication
(10) Pub. No.: US 2025/0113400 A1
(43) Pub. Date: Apr. 3, 2025

(54) INFORMATION PROCESSING APPARATUS, CONTROL METHOD THEREOF, AND STORAGE MEDIUM

(71) Applicant: CANON KABUSHIKI KAISHA, Tokyo (JP)

(72) Inventor: Tomoya Kobayakawa, Kanagawa (JP)

(21) Appl. No.: 18/884,202

(22) Filed: Sep. 13, 2024

(30) Foreign Application Priority Data
Sep. 28, 2023 (JP) 2023-168868

(51) Int. Cl. H04W 76/14; H04N 1/00; H04N 1/32

(52) U.S. Cl. CPC H04W 76/14; H04N 1/00464; H04N 1/32406

(57) ABSTRACT

An information processing apparatus determines whether it is possible to communicate with an image forming apparatus via a router. The information processing apparatus executes, based on it being determined that it is not possible to communicate with the image forming apparatus via the router, predetermined processing for displaying at least one message among (i) a message for disabling a band steering function in the router, (ii) a message for setting each SSID of a plurality of access points in which used frequency bands are different and which are enabled by the router to a different character string and, (iii) a message for enabling, in a case where the image forming apparatus does not support a first frequency band, a second frequency band different from the first frequency band in the router.

### BACKGROUND OF THE INVENTION

### Field of the Invention

The present invention relates to an information processing apparatus, a control method thereof, and a storage medium.

### Description of the Related Art

As a method by which a printer and an information processing apparatus communicate, there is a wireless communication method in which Wi-Fi is used. Wireless communication is broadly divided into a method in which a printer and an information processing apparatus communicate by connecting peer-to-peer and a method in which a printer and an information processing apparatus communicate via a router by the printer and the information processing apparatus each connecting with the router. Recently, not only printers but also various apparatuses communicate using Wi-Fi, and considering cases where information processing apparatuses only have one interface, a method in which communication with a plurality of apparatuses is performed via a router is desirable.

Further, as a setup method of wirelessly connecting to a printer and a router from an information processing apparatus, a method as in Japanese Patent Laid-Open No. 2018-191252 is known. Japanese Patent Laid-Open No. 2018-191252 describes a technique in which a PC and a printer communicate by the PC transmitting information related to an access point to which it is connected to the printer, and causing the printer to connect to the access point.

However, when a network is configured via a router serving as an access point, communication between slave devices may become unstable depending on the settings of the router. For example, Wi-Fi Agile Multiband® specified by Wi-Fi Alliance makes efficient use of a plurality of frequency bands (2.4 GHz, 5 GHz, and 6 GHZ). By a router allocating an optimum frequency band to each slave device, network performance can be maximized. When such an access point function is implemented, depending on the positions and distances of slave devices, differences in signal strength may occur due to differences in the frequency bands that the slave devices use. In addition, if different slave devices use the same radio channel in a certain frequency band, radio frequency interference may occur, causing communication to become unstable. In addition, when a printer main body that is a slave device only supports one type of frequency band, if communication between different frequency bands in a router is prohibited and each slave device uses a different frequency band, a case where communication cannot be performed via the router may occur.

In such an environment, a printer and a router can be wirelessly connected by a PC and the printer being wirelessly connected peer-to-peer as in Patent Literature 1 and the PC transmitting a Service Set Identifier (hereinafter, SSID) and a password of the router to the printer. However, there are problems such as that in which in such a wireless connection a PC cannot communicate with a printer via a router.

### SUMMARY OF THE INVENTION

The present invention enables realization of a technique for allowing execution of appropriate processing when an information processing apparatus cannot communicate with an image forming apparatus via a router.

One aspect of the present invention provides a control method for controlling an information processing apparatus, the control method comprising: determining whether it is possible to communicate with an image forming apparatus via a router external to the image forming apparatus and external to the information processing apparatus; and based on it being determined that it is not possible to communicate with the image forming apparatus via the router, execute predetermined processing for displaying at least one message among: (i) a message for disabling a band steering function in the router, (ii) a message for setting each SSID of a plurality of access points in which used frequency bands are different and which are enabled by the router to a different character string, and (iii) a message for enabling, in a case where the image forming apparatus does not support a first frequency band, a second frequency band different from the first frequency band in the router.

Another aspect of the present invention provides an information processing apparatus comprising: one or more memory devices that store a set of instructions; and one or more processors that execute the set of instructions to: determining whether it is possible to communicate with an image forming apparatus via a router external to the image forming apparatus and external to the information processing apparatus; and based on it being determined that it is not possible to communicate with the image forming apparatus via the router, execute predetermined processing for displaying at least one message among: (i) a message for disabling a band steering function in the router, (ii) a message for setting each SSID of a plurality of access points in which used frequency bands are different and which are enabled by the router to a different character string, and (iii) a message for enabling, in a case where the image forming apparatus does not support a first frequency band, a second frequency band different from the first frequency band in the router.

Still another aspect of the present invention provides a non-transitory computer-readable storage medium, the storage medium storing a program for causing a computer to execute each step of controlling an information processing apparatus, the method comprising: determining whether it is possible to communicate with an image forming apparatus via a router external to the image forming apparatus and external to the information processing apparatus; and based on it being determined that it is not possible to communicate with the image forming apparatus via the router, execute predetermined processing for displaying at least one message among: (i) a message for disabling a band steering function in the router, (ii) a message for setting each SSID of a plurality of access points in which used frequency bands are different and which are enabled by the router to a different character string, and (iii) a message for enabling, in a case where the image forming apparatus does not support a first frequency band, a second frequency band different from the first frequency band in the router.

Further features of the present invention will be apparent from the following description of exemplary embodiments with reference to the attached drawings.

### BRIEF DESCRIPTION OF THE DRAWINGS

FIG. 1 is a diagram illustrating an example of a configuration of a system according to an embodiment of the present invention.

FIGS. 2A and 2B are block diagrams illustrating hardware configurations of an information processing apparatus and a printer according to the embodiment.

FIG. 3A and 3B are a flowchart for explaining a setup procedure for the information processing apparatus to wirelessly connect the printer with a router according to a first embodiment.

FIG. 4 is a diagram illustrating an example of a network troubleshooting web manual prompting screen displayed in step S310 of FIG. 3B.

FIG. 5 is a diagram illustrating an example of a network troubleshooting web manual guidance screen according to the first embodiment.

FIG. 6 is a flowchart for explaining a procedure for the information processing apparatus to display a network troubleshooting web manual and for the information processing apparatus to then wirelessly connect with a router according to a second embodiment.

FIG. 7 is a flowchart for explaining a procedure for the information processing apparatus to determine whether a Wi-Fi Agile Multiband-related function of a router wirelessly connected with the information processing apparatus is enabled and display an appropriate web manual according to a third embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

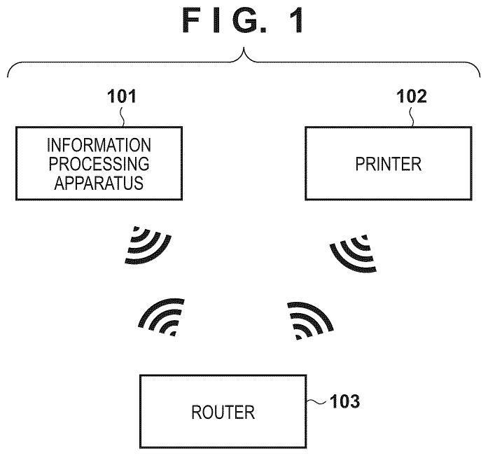

FIG. 1 is a diagram illustrating an example of a configuration of a system according to an embodiment of the present invention.

The system includes an information processing apparatus 101, a printer (image forming apparatus) 102, and a router 103, and the information processing apparatus 101 and the printer 102 are wirelessly connected via the router 103. In the embodiment, it is assumed that the information processing apparatus 101 and the router 103 and the printer 102 and the router 103 are connected using a communication method that is based on an IEEE 802.11 series standard. The communication method that is based on the IEEE 802.11 series standard is, specifically, Wireless Fidelity (Wi-Fi)®. Therefore, the information processing apparatus 101 can communicate with the printer 102 via the router 103. The information processing apparatus 101 needs a printer driver to transmit print commands and the like, and the printer driver is installed on the information processing apparatus 101 from, for example, a driver installer or the like. At that time, a print port for communicating with the printer 102 is created in the information processing apparatus 101, and print commands are transmitted to the printer 102 using the print port. With this, the printer 102 can execute printing according to the print commands received from the information processing apparatus 101.

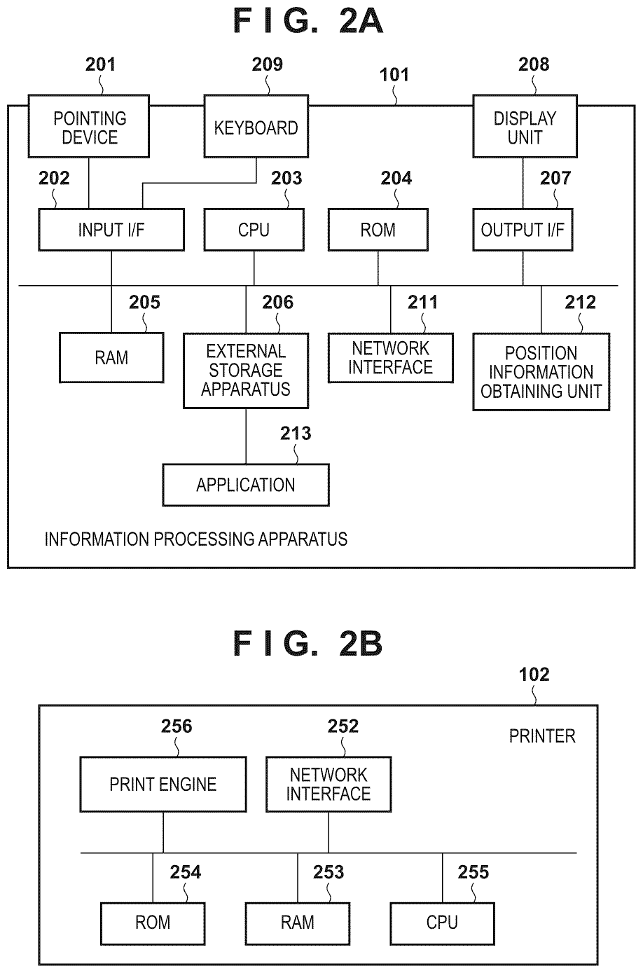

FIGS. 2A and 2B are block diagrams illustrating hardware configurations of the information processing apparatus 101 and the printer 102 according to the embodiment.

FIG. 2A is a block diagram illustrating a hardware configuration of the information processing apparatus 101. The information processing apparatus 101 includes an input interface (I/F) 202, a CPU 203, a ROM 204, a RAM 205, an external storage apparatus 206, an output interface (I/F) 207, a display unit 208, a keyboard 209, and a pointing device 210. The information processing apparatus 101 further includes a network interface 211, a position information obtaining unit 212, and an application 213. The ROM 204 stores an initialization program and the like, and the external storage apparatus 206 stores an operating system (OS) and programs including the application 213 as well as a printer driver and other various kinds of data. The application 213 is installed on the information processing apparatus 101 from outside by, for example, a store application program. Further, the application 213 is an application provided by a vendor of the printer 102. The application 213 may include additional functions other than a function for performing network setup of the printer 102. The additional functions are specifically, for example, a function for performing a setup other than a network setup of the printer 102, a function for transmitting a print job for causing the printer 102 to execute a print job, and a function for transmitting a scan job for causing the printer 102 to execute a scan. The RAM 205 is used as an area for loading various programs stored in the external storage apparatus 206 and as a working memory of the CPU 203. Hereinafter, description will be given using as an example an embodiment in which Microsoft Corporation's Windows® is used as an OS. The network interface 211 controls processing for wireless communication and communication via a wired LAN cable. The position information obtaining unit 212 includes, for example, a GPS function and obtains position information of the information processing apparatus 101.

FIG. 2B is a block diagram illustrating a hardware configuration of the printer 102.

The printer 102 includes a network interface 252, a RAM 253, a ROM 254, a CPU 255, and a print engine 256. The network interface 252 controls processing for wireless communication and communication via a wired LAN cable. The RAM 253 is used as a main memory and a working memory of the CPU 255 and includes a reception buffer for temporarily storing received print commands, print data, and the like and also stores various kinds of data. The print engine 256 performs printing based on data stored in the RAM 253. The ROM 254 stores various control programs and data to be used by the respective control programs, and the CPU 255 controls respective units of the printer 102 according to those control programs.

Here, distribution of processing between the information processing apparatus 101 and the printer 102 has been described as above as an example but is not particularly limited to such an embodiment and may be of another form. The embodiment of the system will be described based on the above configuration.

### Wi-Fi Agile Multiband

Wi-Fi Agile Multiband is a function conforming to IEEE 802.11v, IEEE 802.11r, and IEEE 802.11k standards and is a function for controlling a communication apparatus 151 to connect with an appropriate network according to states of networks around the communication apparatus 151. This function is also referred to as a band steering function in the following.

In the embodiment, it is assumed that the information processing apparatus 101 and the printer 102 support the Wi-Fi Agile Multiband® function and can communicate as STAs supporting Wi-Fi Agile Multiband. It is assumed that the information processing apparatus 101 and the printer 102 also support a Wi-Fi 6® function, which is a function conforming to an IEEE 802.11ax standard. With this, it is assumed that the information processing apparatus 101 and the printer 102 can execute operations as STAs supporting Orthogonal Frequency-Division Multiple Access (OFDMA) and Target Wake Time (TWT) as functions of Wi-Fi 6. The information processing apparatus 101 and the printer 102, which are STAs, can reduce power consumption by causing the communication function to transition to a sleep state when there is no need for signal reception standby. The information processing apparatus 101 and the printer 102 may support, specifically, a Wi-Fi 6E® function as the Wi-Fi 6 function. That is, the information processing apparatus 101 and the printer 102 may be capable of communicating in a 6-GHz band (5.925 GHz to 7.125 GHZ). In the 6-GHz band, unlike a 5-GHz band, there is no band in which Dynamic Frequency Selection (DFS) is performed. Therefore, communication disconnections due to DFS standby time do not occur in communication in the 6-GHz band.

As described above, in the present embodiment, the information processing apparatus 101 and the printer 102 support both Wi-Fi Agile Multiband and Wi-Fi 6 but are not limited to this embodiment. For example, the information processing apparatus 101 and the printer 102 may support Wi-Fi Agile Multiband but not support Wi-Fi 6. As will be described later, the problems of the present invention may occur even in a situation in which one of the information processing apparatus 101 and the printer 102 does not support Wi-Fi Agile Multiband but the other of the information processing apparatus 101 and the printer 102 supports Wi-Fi Agile Multiband. Therefore, one of the information processing apparatus 101 and the printer 102 need not support Wi-Fi Agile Multiband.

The router 103 in which this function is enabled enables a plurality of access points, each using a different frequency band, and sets the SSID of each access point to the same name. Specifically, for example, it is assumed that one router in which the band steering function is enabled activates a first access point with which connection can be established in a first frequency band and a second access point with which connection can be established in a second frequency band. When a communication environment in which the first frequency band is used becomes unstable while the printer 102 is connected to the first access point, the router 103 instructs the printer 102 to switch (change) the connection destination to the second access point, which forms a network with a better communication environment, the network being one in which the second frequency band is used. With this, the printer 102 switches the connection destination to the second access point.

Similarly, when a communication environment in which the first frequency band is used becomes unstable while the information processing apparatus 101 is connected to the first access point, the router 103 instructs the information processing apparatus 101 to switch the connection destination to the second access point. With this, the information processing apparatus 101 switches the connection destination to the second access point. Whether the communication environment is unstable is determined by the router 103 based on a radio field strength or the amount of noise radio waves identified based on information received by the router 103 from the printer 102 or the information processing apparatus 101, the number of apparatuses connected to each access point enabled by the router 103, and the like. With this, after connecting with one of the plurality of access points, the information processing apparatus 101 or the printer 102, which are clients supporting the band steering function, can automatically switch the connection destination to another access point that uses a frequency band with a good communication environment. That is, in the present embodiment, it is assumed that the printer 102 can use a plurality of frequency bands including the first frequency band and the second frequency band. Further, it is assumed that one router in which the band steering function is enabled activates a first access point with which a connection can be established in a first frequency band and a second access point with which a connection can be established in a second frequency band. The printer 102 can use only one frequency band and need not execute connection destination switching that is based on the band steering function. In that form, the information processing apparatus 101 can execute connection destination switching that is based on the band steering function, and so, problems to be described below may occur.

### Direct Connection Method

A direct connection refers to an embodiment in which apparatuses wirelessly connect with each other directly (i.e., peer-to-peer) without going through an external apparatus, such as the router 103. A direct connection is also referred to as a peer-to-peer connection (P2P connections). The printer 102 can operate in a mode (direct connection mode) for communicating using a direct connection as one of the connection modes. In Wi-Fi communication, there are a plurality of modes such as software AP mode and Wi-Fi Direct (WFD) mode for communicating by direct connection.

A mode in which a direct connection is executed by WFD is called WFD mode. WFD is a standard established by Wi-Fi Alliance and is a standard included in an IEEE 802.11 series communication standard. In WFD mode, after a device to be a communication partner is found using a device search command, P2P group owner (GO) and P2P client roles are decided and then remaining wireless connection processing is performed. The group owner corresponds to a Wi-Fi master station (master device) and the client corresponds to a Wi-Fi slave station (slave device). This role decision corresponds to, for example, GO Negotiation in P2P. In WFD mode in a state before role decision is performed, the printer 102 is in a state in which it is neither a master station nor a slave station. Specifically, between devices that perform communication, one device first issues a device search command and searches for a device to connect with in WFD mode. When the other device, which is a communication partner, is found, information related to services and functions that can be provided to each other is confirmed between the two devices. This device provision information confirmation is optional and not mandatory. This device provision information confirmation phase corresponds to, for example, P2P's Provision Discovery.

Next, by mutually confirming this device provision information, it is decided which device will assume the role of the P2P client and which will assume the role of the P2P group owner. Then, once the client and the group owner have been decided, the two exchange parameters for performing WFD communication. Based on the exchanged parameters, the P2P client and group owner perform remaining wireless connection processing and IP connection processing. In WFD mode, the printer 102 may always operate as a GO without executing the above GO Negotiation. That is, the printer 102 may operate in WFD mode which is Autonomous GO mode. A state in which the printer 102 is operating in WFD mode is in other words, for example, a state in which a connection using WFD has not been established but the printer 102 is operating as a GO or a state in which connection using WFD has been established and the printer 102 is operating as a GO.

In software AP mode, between devices (e.g., e information processing apparatus 101 and printer 102) that perform communication, one device (e.g., information processing apparatus 101) is a client that serves a role of requesting various services. Further, the other device realizes the functions of an AP in Wi-Fi according to software settings. A software AP corresponds to a Wi-Fi master station and the client corresponds to a Wi-Fi slave station. In software AP mode, the client searches for a device that is a software AP using a device search command. When a software AP is found, the client and the software AP perform remaining wireless connection processing (wireless connection establishment, etc.) and then IP connection processing (IP address assignment, etc.). Regarding commands and parameters to be transmitted and received when wireless connection is realized between the client and the software AP, those specified in a Wi-Fi standard may be used, and description here will be omitted.

In the present embodiment, when the printer 102 establishes and maintains a direct connection, the printer 102 operates as a master station in the network to which it belongs. A master station is an apparatus for constructing a wireless network and is an apparatus for providing a slave station with parameters to be used to connect to the wireless network. The parameters to be used to connect to the wireless network are, for example, parameters related to a channel used by the master station. By receiving the parameters, the slave station connects to the wireless network constructed by the master station using the channel used by the master station. In direct connection mode, the printer 102 operates as a master station, and so the printer 102 can decide which frequency band to use or which channel to use for communication in direct connection mode. In the present embodiment, it is assumed that the printer 102 can use channels corresponding to a 2.4-GHz frequency band and channels corresponding to a 5-GHz frequency band for communication in direct connection mode. Further, it is assumed that a user can arbitrarily set which frequency band to use (i.e., which frequency band channel to use) using settings according to a setting screen. That is, if 2.4 GHz is selected in the setting screen, the printer 102 will use channels corresponding to the 2.4-GHz frequency band for communication in direct connection mode.

Meanwhile, if 5 GHz is selected in the setting screen, the printer 102 will use channels corresponding to the 5-GHz frequency band for communication in direct connection mode. However, in the embodiment, it is assumed that even if 5 GHz is selected in the setting screen, the printer 102 will not use channels corresponding to a Dynamic Frequency Selection (DFS) band in the 5-GHz frequency band for communication in direct connection mode. In other words, it is assumed that the printer 102 only uses channels corresponding to a frequency band other than the DFS band in the 5-GHz frequency band for communication in direct connection mode. When a radar wave of a frequency band corresponding to a channel of the DFS band is detected while using that channel, the channel currently being used must be changed. Such a frequency band for which channel change may occur due to detection of a radar wave is called the DFS band. In cases such as those where a radio chip supporting the DFS function is used, for example, it may be possible to use channels corresponding to the Dynamic Frequency Selection (DFS) band in the 5-GHz frequency band for communication in direct connection mode. The channels decided as channels to be used in direct connection mode are used in communication via a direct connection. Further, the channels are also used to transmit Beacon signals as a master station, transmit responses to received commands, and the like. That is, the channels are used not only for communication processing in direct connection mode in a state in which a direct connection is established but also for communication processing in direct connection mode in a state in which a direct connection is not established.

In the above description, an embodiment in which the user can set whether to use channels corresponding to the 2.4-GHz frequency band or channels corresponding to 5-GHz frequency band in direct connection mode, but the present invention is not limited to this embodiment. An embodiment in which by acceptance of designation of a channel number from the user, specifically channels of what number to be used in direct connection mode can be set by the user may be taken. In addition, an embodiment in which channels used in direct connection mode are set in advance in the printer 102 rather than being arbitrarily set by the user may be taken.

In the above description, an embodiment in which the printer 102 can use the 2.4-GHz frequency band and the 5-GHz frequency band has been described, but the present invention is not limited to this embodiment. Another frequency band may be used, and in processing in which the 2.4-GHz frequency band and the 5-GHz frequency band are used in the present embodiment, another frequency band may be used. For example, in an IEEE 802.11ad standard, since a 60-GHz frequency band can be used, 60 GHz may be used as the above other frequency band. The printer 102 may be capable of using only the 2.4-GHz frequency band. In that case, 2.4 GHz is used in an infrastructure connection and in a direct connection.

### Infrastructure Connection Method

An infrastructure connection is a connection mode for devices to connect to an AP (e.g., AP activated by the router 103) that controls a network of apparatuses (e.g., information processing apparatus 101 and printer 102) that perform communication and communicate with each other via the AP. The printer 102 can operate in a mode (direct infrastructure connection mode) for communicating using an infrastructure connection as one of the connection modes.

In an infrastructure connection, each device searches for an AP using a device search command. When an AP is found, the device and the AP perform remaining wireless connection processing (wireless connection establishment, etc.) and then IP connection processing (IP address assignment, etc.). Regarding commands and parameters to be transmitted and received when wireless connection is realized between the device and the AP, those specified in a Wi-Fi standard may be used, and description here will be omitted.

In the embodiment, when the printer 102 operates in an infrastructure connection, the router 103 operates as a master station and the printer 102 operates as a slave device. That is, in the embodiment, an infrastructure connection refers to a connection between the printer 102 operating as a slave device and an apparatus operating as a master device. When the printer 102 and the information processing apparatus 101 establishes an infrastructure connection with the router 103, communication via the router 103 is possible between the printer 102 and the information processing apparatus 101. Since a channel to be used for communication in an infrastructure connection is decided by the router 103, the printer 102 executes communication in an infrastructure connection using the channel decided by the router 103. In the embodiment, it is assumed that the printer 102 can use a channel corresponding to a 2.4-GHz frequency band and a channel corresponding to a 5-GHz frequency band for communication in an infrastructure connection. The printer 102 can use channels corresponding to the DFS band in the 5-GHz frequency band for communication in an infrastructure connection. In order to communicate with the printer 102 via the router 103, the information processing apparatus 101 needs to recognize that the printer 102 belongs to a network formed by the router 103 and to which the information processing apparatus 101 belongs.

### Connection Setting Mode

The printer 102 can operate in connection setting mode. By receiving a setting command from the information processing apparatus 101 while operating in connection setting mode, the printer 102 starts operation in a mode corresponding to the setting command. Specifically, for example, when an SSID or a password of an access point enabled by the router 103 is received as a setting command, the printer 102 operates in infrastructure connection mode by establishing a connection with the access point. A trigger for the printer 102 to start operation in connection setting mode may be, for example, the user pressing a connection setting mode button or the printer 102 activating (powering on) for the first time after arrival. The connection setting mode button may be a physical button provided in the printer 102 or may be a software button displayed on a display unit 161 by the printer 102.

Upon starting operation in connection setting mode, the printer 102 enables both Wi-Fi communication and Bluetooth Low Energy (BLE) communication. Specifically, the printer 102 enables an AP (connection setting AP) inside the printer 102 dedicated to connection setting mode as processing for enabling Wi-Fi communication. With this, the printer 102 enters a state in which it is possible to establish a direct connection using Wi-Fi with the information processing apparatus 101. It is assumed that connection information (SSID and password) for connecting with the connection setting AP is held in advance in the application 213 installed on the information processing apparatus 101 and that the information processing apparatus 101 knows in advance the connection information for connecting with the connection setting AP. An embodiment in which an encryption method is not set in the connection setting AP and a password is not necessary for connecting with the AP may be taken. Therefore, unlike the connection information of an AP that is enabled in direct connection mode, it is assumed that the connection information for connecting with the connection setting AP cannot be arbitrarily changed by the user. In connection setting mode, the printer 102 may connect with the information processing apparatus 101 using Wi-Fi Direct (WFD) instead of typical Wi-Fi. That is, the printer 102 may operate as a Group Owner and receive setting commands from the information processing apparatus 101 using communication by WFD. Since connection setting mode is also a mode for establishing a temporary connection between the printer 102 and the information processing apparatus 101, connection setting mode will be referred to as temporary connection mode in the following description.

### First Embodiment

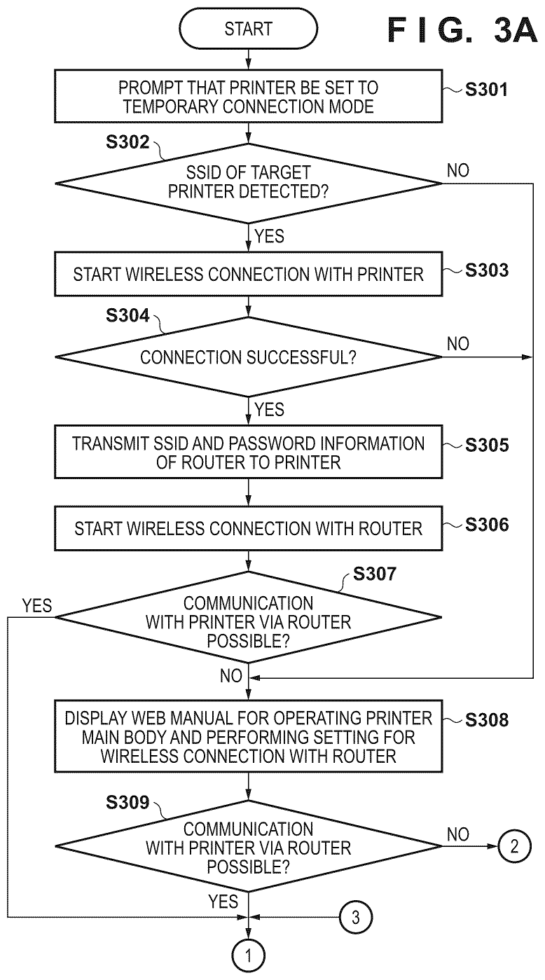

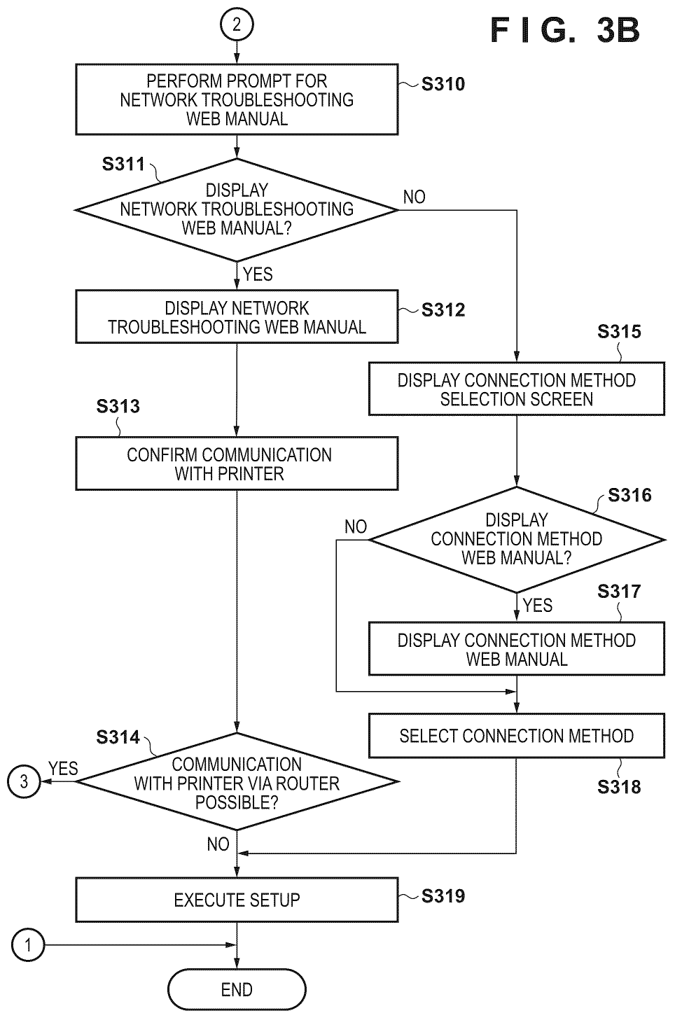

FIG. 3A and 3B are flowcharts for explaining a setup procedure for the information processing apparatus 101 to wirelessly connect the printer 102 with the router 103 according to a first embodiment. Since the processing illustrated in this flowchart is realized by the CPU 203 loading the application 213 to the RAM 205 and executing the application 213, in the following description, it is assumed that the performer of each step of processing is the CPU 203.

First, in step S301, the CPU 203 prompts the user to set the printer 102 to the temporary connection mode. Regarding this setting, it is assumed that the printer 102 can be set to the temporary connection mode by a press of a predetermined button of a touch panel or a physical button of the main body of the printer 102 (both buttons are not illustrated). Here, it is assumed that the SSID of an access point started up (activated) by the printer 102 in the temporary connection mode is independently set by the vendor, and information, which is a manufacturer name, a serial number, and a model name, is set.

Next, the processing proceeds to step S302, and the CPU 203 searches for a nearby router using a Wi-Fi interface and determines whether the printer 102 in the temporary connection mode set in step S301 has been detected. At this time, the CPU 203 also determines from information held in advance by the application 213 whether the printer 102 is a supported model based on the SSID of the printer 102 in the temporary connection mode (SSID of an access point activated by the printer 102 in the temporary connection mode). If it is determined in step S302 that the SSID of the target printer 102 in the temporary connection mode has been detected, the processing proceeds to step S303, and the CPU 203 starts establishment of a wireless connection between the printer 102 in the temporary connection mode and the information processing apparatus 101. As described above, configuration may be taken such that a password is not necessary for wireless connection with the printer 102 in the temporary connection mode or a password is set specific to a vendor and the application 213 knows the password in advance. Meanwhile, if it is determined in step S302 that the SSID of the target printer 102 in the temporary connection mode is not detected, the processing proceeds to step S308, and the CPU 203 executes display of a web manual for operating the main body of the printer 102 ad performing setting for wireless connection with the router 103, which will be described later.

After a wireless connection with the printer 102 has been started in step S303, the processing proceeds to step S304, and the CPU 203 determines whether a connection with the printer 102 has been successfully established. In step S304, if it is determined that a connection with the printer 102 has been successfully established, the processing proceeds to step S305, and otherwise, the processing proceeds to step S308. In step S305, the CPU 203 transmits SSID and password information of the router 103 (SSID and password information of the access point enabled by the router 103) to the printer 102. The information transmitted here is a setting command for the printer 102 to establish an infrastructure connection. Here, the information processing apparatus 101 may hold information of the connected router 103, and in the case of Windows®, an SSID and an encrypted password are stored in the ROM 204 of the information processing apparatus 101 as a Wi-Fi profile. Therefore, the CPU 203 can obtain the SSID and password information of the router 103 by decrypting the encrypted password. Alternatively, there may be cases where the information processing apparatus 101 is not connected with a router 103 and it has not been decided for which router 103 information is to be transmitted to the printer 102. In such cases, the CPU 203 instructs the printer 102 to search for nearby routers, obtains a list of detected SSIDs from the printer 102, and displays the SSID list on the display unit 208 of the information processing apparatus 101. With this, the user selects an SSID from the displayed SSID list, and by displaying a screen prompting input of a corresponding password, information of the router 103 may be obtained. Further, in step S303, the CPU 203 may transmit, to the printer, information indicating a frequency band used to connect with the router 103. The information indicating a frequency band, such as 2.4 GHz and 5 GHz, may be information indicating a frequency band corresponding to a plurality of communication channels or may be information indicating one channel among a plurality of communication channels.

Next, the processing proceeds to step S306, and the CPU 203 starts a wireless connection with the router 103 corresponding to the SSID and password information set in the printer 102 in step S305. Then, the processing proceeds to step S307, and the CPU 203 determines whether it is possible to communicate with the printer 102 via the router 103. Specifically, an Object IDentifier (OID) indicating a device name, a serial number, or the like is designated from the information processing apparatus 101, and a Get Request command is broadcasted on the network using Simple Network Management Protocol (SNMP). Then, if the printer 102 belongs to the same network as the information processing apparatus 101, the information processing apparatus 101 can receive a response, which is a Get Response command, from the printer 102. If a response is thus received, it is determined that the printer 102 has been detected via the router 103. Meanwhile, if the printer 102 does not belong to the same network as the information processing apparatus 101, a response, which is a Get Response command, is not transmitted from the printer 102 to the information processing apparatus 101. Therefore, the information processing apparatus 101 cannot receive a response from the printer 102. In this case, it is determined that the printer 102 has not been detected via the router 103. A case where the printer 102 has been detected via the router 103 corresponds to a case where the information processing apparatus 101 can communicate with the printer 102.

In step S307, if it is determined that the printer 102 has been detected via the router 103, the CPU 203 determines that setting for a wireless connection of the printer 102 and the router 103 has been completed and terminates the processing. Meanwhile, if it is determined that the printer 102 has not been detected via the router 103, the processing proceeds to step S308, and the CPU 203 displays a web manual for prompting the user to operate the main body of the printer 102 and perform setting for wireless connection with the router 103. Here, the operation of the main body of the printer 102 includes an operation of a button on the touch panel or a physical button of the main body of the printer 102, and with this operation, the printer 102 detects nearby access points and identifies SSIDs of the detected access points. Then, the printer 102 displays an SSID list, which is a list of identified SSIDs on a panel (not illustrated) of the main body of the printer 102 and, upon input of a password for the SSID selected by the user from the SSID list, performs setting so as to wirelessly connect the printer 102 and the router 103. Alternatively, some routers are equipped with a function called Wi-Fi Protected Setup, which is specified by Wi-Fi Alliance. For this, an operation for performing a wireless connection between the router 103 and the printer 102 for which guidance for the operation of the main body of the router 103 is provided, is displayed. Further, in order to display a web manual for operating the main body of the printer 102 and performing setting for wireless connection with the router 103, the CPU 203 which executes the application 213 obtains model information from the printer 102. Configuration may be taken so as to then generate a URL for displaying a web manual that accords with that model, activate a browser, and display the web manual for operating the printer 102 of the target model and perform setting for wireless connection with the router 103.

Thus, the user views the web manual displayed in step S308 and performs an operation and then presses a button for proceeding to the next processing, which is displayed in the application 213. With this, the processing proceeds to step S309, and the CPU 203 determines whether it is possible to communicate with the printer 102 via the router 103. Then, if it is determined in step S309 that it is possible to communicate with the printer 102 via the router 103, the CPU 203 determines that setting for a wireless connection of the printer 102 and the router 103 has been completed and terminates the processing.

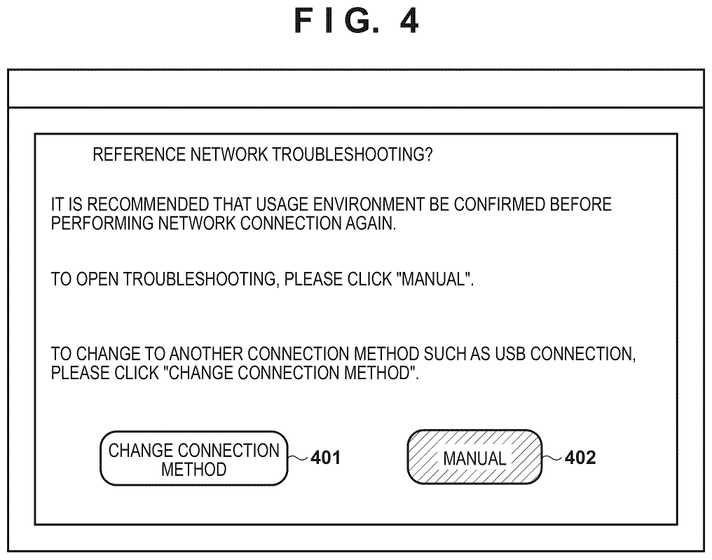

Meanwhile, if it is determined in step S309 that it is not possible to communicate with the printer 102, the CPU 203 proceeds to step S310. In step S310, the CPU 203 displays a network troubleshooting web manual prompting screen. Details thereof will be described later with reference to FIG. 4.

Next, the processing proceeds to step S311, and the CPU 203 determines whether to display a network troubleshooting web manual according to the user's operation on the network troubleshooting web manual prompting screen. If it is determined to display a web manual here, the processing proceeds to step S312, and the CPU 203 activates a browser application program (hereinafter referred to as browser) for displaying a web browser and causes the browser to display a guidance screen as the web manual. The present invention is not limited to an embodiment in which the guidance screen is displayed in the browser, and the guidance screen may be displayed in the application 213 instead of the browser.

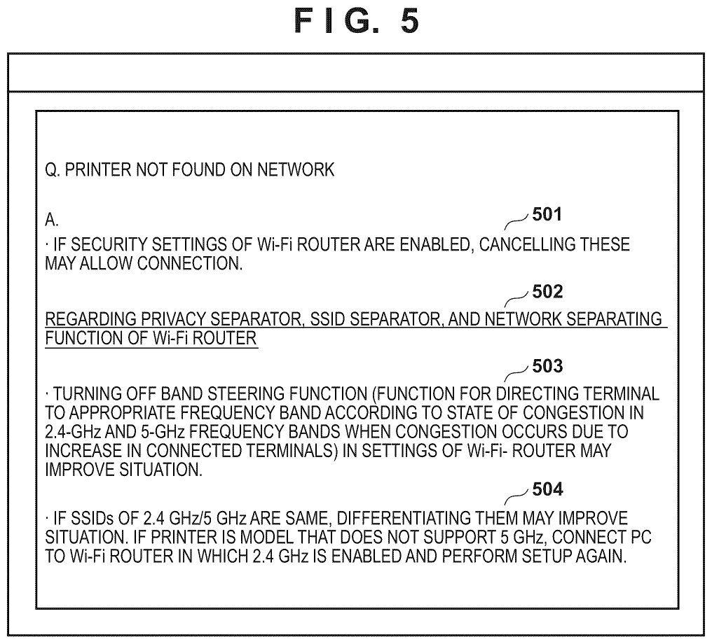

FIG. 5 is a diagram illustrating an example of a network troubleshooting web manual guidance screen according to the first embodiment.

Here, the network troubleshooting web manual describes response methods of responding to several expected causes. For example, in cases where despite the printer 102 and the router 103 being connected, it is not possible to communicate with the printer 102 via the router 103, the following reasons therefor are conceivable.

A case in which slave devices connected to the router 103 cannot communicate with each other due to security settings (privacy separator, network separating function/isolation function, and MAC address filtering) of the router 103 is conceivable. Therefore, the guidance screen includes a message prompting the user to disable (cancel) security setting functions. That message corresponds to a message 501. In the embodiment, a description for a specific operation method of enabling or disabling (cancelling) each security setting is displayed on a web page different from the web page on which the guidance screen is displayed. Therefore, the guidance screen includes a hyperlink 502 for opening that web page. However, the present invention is not limited to this form, and a description of a specific operation method for enabling or disabling each security setting may also be included in the guidance screen.

As another cause, it is conceivable that some routers may be equipped with a band steering function for connecting to a router with a good communication environment by dynamically switching frequency bands and channels, which is called Wi-Fi Agile Multiband. Therefore, the guidance screen includes a message prompting the user to disable the band steering function in the router 103. That message corresponds to a message 503. When the band steering function is disabled in the router 103, a connection destination switch instruction that is based on the band steering function is not transmitted to the printer 102 or the information processing apparatus 101 from the router 103. By setting each of the SSIDs of a plurality of access points in which used frequency bands are different and which are enabled by the router 103 to a different character string, even if the band steering function is enabled in the router 103, it is possible to prevent switching of connection destinations of the printer 102 by the band steering function. Further, by performing the above setting, even if the band steering function is disabled in the router 103, it is possible to prevent switching of connection destinations of the printer 102 by another function, such as a roaming function. Therefore, the guidance screen may include a message prompting the user to set each of the SSIDs of a plurality of access points in which used frequency bands are different and which are enabled by the router 103 to a different character string. That message corresponds to a message 504.

As yet another cause, a case where when the printer 102 only supports a certain frequency band, the router 103 has not enabled a corresponding frequency band is conceivable. Therefore, the guidance screen may include a message prompting the user to change an enabled frequency band setting of the router 103 according to the frequency band supported by the printer 102. Specifically, if the printer 102 only supports the 2.4 GHz frequency band, the router 103 may include a message prompting the user to perform setting for the router 103 so as to only enable an access point that uses 2.4 GHz. The setting for the router 103 so as to only enable an access point that uses 2.4 GHz is in other words, for example, a setting for making it so that the router 103 does not enable an access point that uses a frequency band other than 2.4 GHZ (5 GHZ, etc.). Here, three reasons have been given as examples, but the present invention is not limited to these, and it is assumed that content prompting a change in settings of the router 103 that is conceivable is displayed as a web manual. In addition, since it is assumed that a wireless connection between the information processing apparatus 101 and the router 103 is disconnected by a change in the settings of the router 103, a method of wirelessly connecting the information processing apparatus 101 and the router 103 after the change in the settings of the router 103 may be described.

Thus, after the display of the network troubleshooting manual in step S312, the processing proceeds to step S313, and the CPU 203 confirms communication with the printer 102 via the router 103. Then, the processing proceeds to step S314, and similarly to step S307, the CPU 203 determines whether it is possible to communicate with the printer 102 for which setting for network troubleshooting has been performed via the router 103. If it is determined that it is possible to communicate with the printer 102 via the router 103, the CPU 203 determines that setting for wireless connection between the printer 102 and the router 103 has been completed and terminates the processing. Meanwhile, if it is determined that it is not possible to communicate with the printer 102 via the router 103, the processing proceeds to step S319, and the CPU 203 executes a setup to be described later and terminates the processing.

Further, in step S311, if the CPU 203 determines so as not to display the network troubleshooting web manual, the processing proceeds to step S315, and the CPU 203 displays a screen for selecting a method of connecting the printer 102 and the router 103. Here, the connection method refers to a connection mode for allowing the information processing apparatus 101 and the printer 102 to communicate, such as a wireless connection and a USB connection, and is not limited to the method of connection via the router 103.

Next, the processing proceeds to step S316, and the CPU 203 determines whether the user has caused the web manual, which displays a detailed guidance on connection methods, to be displayed. If it is determined here to display a connection method web manual, the processing proceeds to step S317, and the CPU 203 activates the browser and displays the connection method web manual. This connection method web manual describes guidance on a connection method considering environments with or without a LAN and an environment of a wireless connection used by the user. With this, the user can confirm a method of connecting the information processing apparatus 101 and the printer 102 according to the usage environment and attempt to establish a connection again from the application 213. After the confirmation of the connection method web manual in step S317, the processing proceeds to step S318, and upon accepting selection of a connection method from the user, the CPU 203 advances the processing to step S319. If it is determined in step S316 so as not to display the connection method web manual, the processing proceeds to step S318, and the CPU 203 decides the connection method selected by the user and proceeds to step S319. In step S319, the CPU 203 executes a setup for connecting with the printer 102.

The processing of step S319 will be described in detail. When the network troubleshooting web manual is displayed in step S312, a setup for wireless connection between the printer 102 and the router 103 is executed again from step S301. Meanwhile, when the connection method selection screen is displayed in step S315, a setup is executed according to the connection method decided in step S318. For example, if a wired LAN connection has been selected, the CPU 203 prompts the user to connect the printer 102 and the router 103 by wired LAN and, after the user has connected the printer 102 and the router 103 by wired LAN, determines whether it is possible to communicate with the printer 102 via the router 103, similarly to step S309. Further, if a USB connection has been selected, the CPU 203 prompts the user to connect the printer 102 and the information processing apparatus 101 by USB and, after the user has connected the printer 102 and the information processing apparatus 101 by USB, performs communication confirmation in which SNMP is used via USB. If a wireless connection has been selected, a wireless connection setup is executed again from step S301.

FIG. 4 is a diagram illustrating an example of a network troubleshooting web manual prompting screen displayed in step S310 of FIG. 3B.

At this time, the CPU 203 which executes the application 213 displays a dialog illustrated in FIG. 4 and prevents a close button of a window screen from being pressed. In this dialog, a title and descriptive text are stated, and two buttons 401 and 402 are arranged horizontally at the bottom. In the title, text to the effect of referencing the network troubleshooting web manual is stated. Further, in the descriptive text, text recommending to confirm the user's environment and prompting the user to press the “manual” button 402 as troubleshooting is stated. Further text prompting that the “change connection method” button 401 be pressed when changing to a different connection method is stated. The “manual” button 402 is displayed in a colored manner in order to draw the user's attention. When the “manual” button 402 is pressed, a transition is made to display of the manual of step S312 of FIG. 3B described above. Further, when the “change connection method” button 401 is pressed, a transition is made to display of the connection method selection screen in step S315 of FIG. 3B. With this, the CPU 203 which executes the application 213 can emphasizes a prompt for a network troubleshooting web manual to the user and perform a change of settings for the router 103 described above.

As described above, according to the first embodiment, when the information processing apparatus 101 executes a setup for wireless connection between the router 103 and the printer 102, the information processing apparatus 101 transmits wireless setting information to the printer 102. Then, if the information processing apparatus 101 cannot communicate with the printer 102, a prompt for a web manual prompting a change of a Wi-Fi Agile Multiband-related setting of the router 103 is performed as network troubleshooting. With this, the user can reference the network troubleshooting web manual and appropriately change the settings of the router 103. Thus, the information processing apparatus 101 can enter a state in which it is possible to communicate with the printer 102 via the router 103.

### Second Embodiment

When the user performs an operation according to the network troubleshooting web manual provided by the application of the system according to the first embodiment, a wireless connection between the information processing apparatus and the router may be disconnected depending on the router. Therefore, in a second embodiment, an example in which guidance for a response method for when a wireless connection between the information processing apparatus 101 and the router 103 is disconnected is provided will be described. Since the configuration of the system according to the second embodiment, the hardware configurations of the information processing apparatus 101 and the printer 102, and the like are the same as those of the above first embodiment, the description thereof will be omitted.

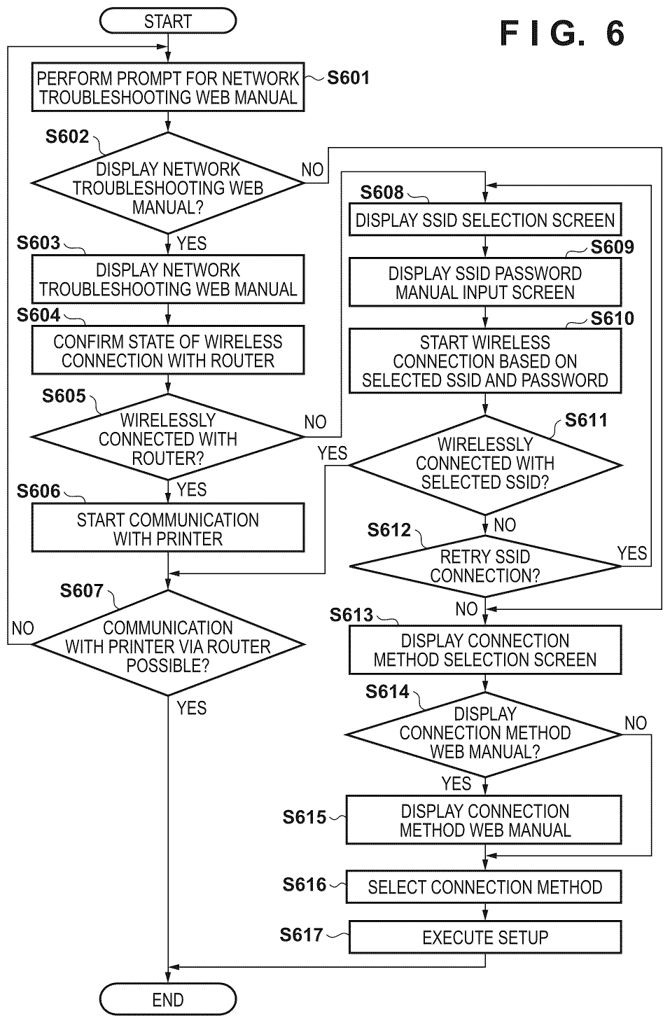

FIG. 6 is a flowchart for explaining a procedure for the information processing apparatus 101 to display the network troubleshooting web manual and for the information processing apparatus 101 to then wirelessly connect with the router 103 according to the second embodiment. The processing illustrated in this flowchart is realized by the CPU 203 executing the application 213.

Since steps S601 to S603 of FIG. 6 are the same as the processing of steps S310 to S312 of FIG. 3B described above, the description thereof will be omitted. In step S604, the CPU 203 confirms the state of wireless connection with the router 103. In the above first embodiment, communication with the printer 102 is confirmed in step S313 of FIG. 3B. However, here, the user has viewed the network troubleshooting web manual displayed in step S603 and has changed the settings of the router 103. Therefore, it is conceivable that the SSID with which the information processing apparatus 101 is connected is changed to another SSID and a wireless connection between the information processing apparatus 101 and the router 103 is disconnected. In that case, the information processing apparatus 101 cannot confirm the communication with the printer 102 via the router 103. Therefore, the state of wireless connection between the information processing apparatus 101 and the router 103 is confirmed in advance in step S604.

Then, the processing proceeds to step S605, and the CPU 203 determines whether the information processing apparatus 101 is wirelessly connected with the router 103. In step S605, if the CPU 203 determines that the router 103 is wirelessly connected, the processing proceeds to step S606, and the CPU 203 confirms the communication with the printer 102 via the router 103. Then, the processing proceeds to step S607, and the CPU 203 determines whether it is possible to communicate with the printer 102 via the router 103. Here, if it is determined that it is possible to communicate the printer 102 via the router 103, it is determined that a setup for wireless connection between the printer 102 and the router 103 is completed, and the processing is terminated. Meanwhile, if it is determined in step S607 that it is not possible to communicate the printer 102 via the router 103, the processing returns to step S601, and the CPU 203 displays the network troubleshooting web manual prompting screen again.

Further, in step S605, if the CPU 203 determines that the router 103 is not wirelessly connected, the processing proceeds to step S608, and the CPU 203 displays an SSID selection screen on the display unit 208. Here, the information processing apparatus 101 displays a list of detected nearby SSIDs on the screen and accepts selection of an SSID with which to establish a connection among them. Next, the processing proceeds to step S609, and the CPU 203 displays a screen for accepting input of a password corresponding to the SSID selected in step S608. Then, the processing proceeds to step S610, and the CPU 203 starts a wireless connection between the information processing apparatus 101 and the router 103 based on the SSID selected in step S608 and the password inputted in step S609. Then, the processing proceeds to step S611, and the CPU 203 determines whether the information processing apparatus 101 is wirelessly connected the selected SSID. In step S611, if it is determined that a wireless connection has been established with the selected SSID, the processing proceeds to step S607, and the CPU 203 determines whether it is possible to communicate with the printer 102 via the router 103. Thereafter, the processing is similar to that described above, and so, the description thereof will be omitted.

Meanwhile, in step S611, if the CPU 203 determines that a wireless connection could not be established with the selected SSID, the processing proceeds to step S612, and the CPU 203 determines whether to retry an SSID connection based on the user's operation. Here, if it is determined that the user has instructed to retry an SSID connection, the processing proceeds to step S608, and the SSID selection screen is displayed. Meanwhile, if it is determined in step S612 that the user has instructed not to retry an SSID connection, the processing proceeds to step S613, and the CPU 203 displays a connection method selection screen. Since steps S613 to S617 thereafter are similar to the processing of steps S315 to S319 of FIG. 3B described above, the description thereof will be omitted.

As described above, according to the second embodiment, the information processing apparatus 101 executes a setup in which a wireless connection with the printer 102 via the router 103 is used. Then, similarly to the above first embodiment, if the information processing apparatus 101 cannot communicate with the printer 102 via the router 103, the information processing apparatus 101 displays the network troubleshooting web manual. By the user confirming the network troubleshooting web manual and changing the settings of the router 103, a wireless connection between the information processing apparatus 101 and the router 103 may be disconnected. In such a case, the state of wireless connection between the information processing apparatus 101 and the router 103 is confirmed and then the SSID selection screen is displayed, and by inputting an SSID with which to establish a connection and a password, the user can establish a wireless connection between the information processing apparatus 101 and the router 103.

With this, even if a connection between the information processing apparatus 101 and the router 103 is disconnected in the process of changing settings according the network troubleshooting web manual, guidance for a response method therefor can be appropriately provided. Thus, even when a connection between the information processing apparatus 101 and the router 103 is disconnected, it is possible to establish a state in which the information processing apparatus 101 can communicate with the printer 102 via the router 103.

### Third Embodiment

In the above first embodiment, network troubleshooting for when the information processing apparatus 101 and the printer 102 cannot communicate after the information processing apparatus 101 has transmitted wireless setting information to the printer 102 has been described. In the first embodiment, a prompt is given for display of the web manual prompting a change of the Wi-Fi Agile Multiband-related setting of the router 103. However, cases where the information processing apparatus 101 and the printer 102 cannot communicate are not limited to cases where a Wi-Fi Agile Multiband-related function of an access point is enabled. For example, cases such as that in which a privacy separator function of an access point is enabled are also included in cases where the information processing apparatus 101 and the printer 102 cannot communicate.

Therefore, in the above first embodiment, there is a possibility that execution may be performed even when the Wi-Fi Agile Multiband-related function of the access point is not enabled. In such a case, there is a concern that the user may be unnecessary prompted to change the settings of the router. Therefore, a prompt for displaying a web manual prompting a change of a Wi-Fi Agile Multiband-related setting is preferably performed when it has been confirmed that the privacy separator function of the access point is enabled.

Therefore, in a third embodiment, an embodiment in which an appropriate prompt for the web manual is performed by confirming whether the Wi-Fi Agile Multiband-related setting of the router 103 is enabled from the information processing apparatus 101 will be described. Since the configuration of the system according to the third embodiment, the hardware configurations of the information processing apparatus 101 and the printer 102, and the like are the same as those of the above first embodiment, the description thereof will be omitted.

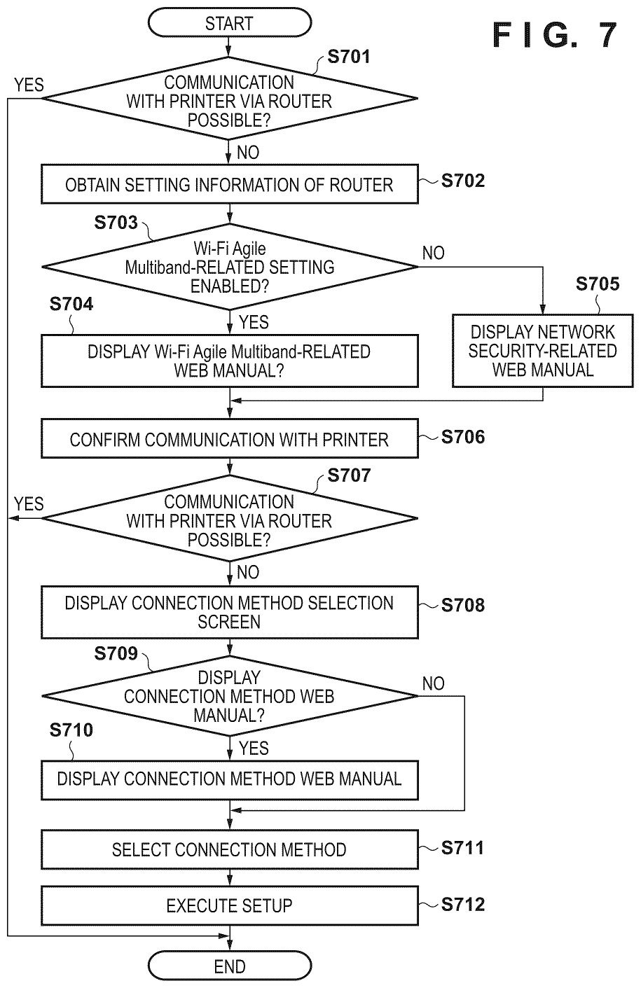

FIG. 7 is a flowchart for explaining a procedure for the information processing apparatus 101 to determine whether a Wi-Fi Agile Multiband-related function of the router 103 wirelessly connected with the information processing apparatus 101 is enabled and then display a web manual according to the third embodiment. The processing illustrated in this flowchart is realized by the CPU 203 executing the application 213.

Since the processing of step S701 is similar to that of step S309 of FIG. 3A, the description thereof will be omitted. In step S701, if it is determined that it is not possible to communicate with the printer 102 via the router 103, the processing proceeds to step S702, and the CPU 203 obtains setting information of the router 103 wirelessly connected with the information processing apparatus 101. Here, in order to obtain the setting information of the router 103, an Application Programming Interface (API) may be provided by a respective company of the router. By incorporating the API provided by the respective company of the router, the CPU 203 can obtain the setting information of the router 103 wirelessly connected to the information processing apparatus 101. For example, if an API for obtaining an enabled status of the Wi-Fi Agile Multiband-related function is provided, by the CPU 203 calling that API, a request command is transmitted from the information processing apparatus 101 to the router 103. The router 103 transmits response information to the information processing apparatus 101 according to the contents of the request received from the information processing apparatus 101. Thus, by receiving the response information from the router 103, the information processing apparatus 101 can determine the enabled status of the Wi-Fi Agile Multiband-related function based on whether the response information is True or False. Further, regarding the setting information of the router 103, it is possible to obtain not only the Wi-Fi Agile Multiband-related setting but also information such as an SSID and an encryption method.

Next, the processing proceeds to step S703, and the CPU 203 determines whether the Wi-Fi Agile Multiband-related setting of the router 103 is enabled. In step S703, if the CPU 203 determines that the Wi-Fi Agile Multiband-related setting is enabled, the processing proceeds to step S704, and the CPU 203 displays a Wi-Fi Agile Multiband-related web manual on the display unit 208 and proceeds to step S706. The Wi-Fi Agile Multiband-related web manual provides guidance that a solution may be to disable the Wi-Fi Agile Multiband-related function or to arbitrarily set an SSID for each frequency band as described in step S312 of FIG. 3B.

Meanwhile, in step S703, if the CPU 203 determines that the Wi-Fi Agile Multiband-related setting is not enabled, the processing proceeds to step S705, and the CPU 203 displays a network security-related web manual on the display unit 208 and proceeds to step S706. The network security-related web manual provides guidance that communication will be possible by disabling security settings (privacy separators, a network separating function/isolation function, and MAC address filtering) of the router 103 described in step S312 of FIG. 3B.

In step S706, the CPU 203 executes processing similar to that in step S313 of FIG. 3B, and so, description thereof will be omitted. Next, the processing proceeds to step S707, and the CPU 203 determines whether it is possible to communicate with the printer 102 via the router 103, similarly to steps S307 and S314 of FIG. 3B. In step S707, if it is determined that it is possible to communicate with the printer 102 via the router 103, the CPU 203 determines that setting for a wireless connection of the printer 102 and the router 103 has been completed and terminates the processing.

Meanwhile, in step S707, if the CPU 203 determines that it is not possible to communicate with the printer 102 via the router 103, the processing proceeds to step S708. In step S708, the CPU 203 displays a screen for selecting a method of connecting the printer 102 and the router 103. Since the processing of steps S709 to S712 is similar to that of steps S316 to S319 of FIG. 3B described above, the description thereof will be omitted.

As described above, according to the third embodiment, by the information processing apparatus 101 executing a setup in which a wireless connection with the printer 102 via the router 103 is used, a response method for when the information processing apparatus 101 cannot communicate with the printer 102 via the router 103 can be suggested. The information processing apparatus according to the third embodiment can determine whether the Wi-Fi Agile Multiband-related setting of the router is enabled and displays the Wi-Fi Agile Multiband-related web manual only when the setting is enabled. With this, when the information processing apparatus cannot communicate with the printer via the router, the user can be appropriately prompted to change the settings of the router according to whether the Wi-Fi Agile Multiband-related setting of the router is enabled.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-168868, filed Sep. 28, 2023 which is hereby incorporated by reference herein in its entirety.

What is claimed is:

1. A control method for controlling an information processing apparatus, the control method comprising:
determining whether it is possible to communicate with an image forming apparatus via a router external to the image forming apparatus and external to the information processing apparatus; and
based on it being determined that it is not possible to communicate with the image forming apparatus via the router, execute predetermined processing for displaying at least one message among: (i) a message for disabling a band steering function in the router, (ii) a message for setting each SSID of a plurality of access points in which used frequency bands are different and which are enabled by the router to a different character string, and (iii) a message for enabling, in a case where the image forming apparatus does not support a first frequency band, a second frequency band different from the first frequency band in the router.

2. The control method according to claim 1, further comprising:
transmitting, to the image forming apparatus, setting information for connecting with the router,
wherein the determination as to whether it is possible to communicate with the image forming apparatus via the router is executed after the setting information has been transmitted to the image forming apparatus.

3. The control method according to claim 2, wherein
the setting information is transmitted to the image forming apparatus via a connection between the information processing apparatus and the image forming apparatus that does not go through the router,
a connection between the information processing apparatus and the router is started after the setting information has been transmitted to the image forming apparatus, and
the determination as to whether it is possible to communicate with the image forming apparatus via the router is executed after the connection between the information processing apparatus and the router has been started.

4. The control method according to claim 1, wherein
specific processing for displaying a manual related to establishing a connection between the image forming apparatus and the router by an operation on the image forming apparatus is executed based on it being determined that it is not possible to communicate with the image forming apparatus via the router.

5. The control method according to claim 4, wherein
the manual indicates establishing a connection between the image forming apparatus and the router by a user selecting an SSID from a list of SSIDs of access points detected by the image forming apparatus, the list being displayed by the image forming apparatus.

6. The control method according to claim 4, wherein
the manual indicates establishing a connection between the image forming apparatus and the router according to Wi-Fi Protected Setup.

7. The control method according to claim 4, wherein
the manual is a web manual, and
the specific processing includes processing for activating a browser and displaying the web manual.

8. The control method according to claim 4, wherein
the determination as to whether it is possible to communicate with the image forming apparatus via the router is executed again after the specific processing has been executed.

9. The control method according to claim 8, wherein
the predetermined processing is executed based on it also being determined after the specific processing has been executed that it is not possible to communicate with the image forming apparatus via the router.

10. The control method according to claim 9, wherein
the predetermined processing includes processing for displaying a predetermined screen for accepting an operation for displaying the at least one message, and
based on the operation for displaying the at least one message being accepted in the predetermined screen, processing for displaying a manual that displays the at least one message is executed.

11. The control method according to claim 10, wherein
the manual that displays the at least one message is a web manual, and
the processing for displaying the manual that displays the at least one message includes processing for activating a browser.

12. The control method according to claim 10, wherein
the predetermined screen is capable of accepting an operation for selecting a connection method of connecting the image forming apparatus and the router, and
in a case where the operation for selecting the connection method has been accepted, a selection screen for selecting a connection method in a connection between the image forming apparatus and the router is displayed.

13. The control method according to claim 12, wherein
the selection screen includes at least one option among a wireless connection, a USB connection, and a wired LAN connection.

14. The control method according to claim 13, further comprising:
prompting establishment of a connection between the router and the image forming apparatus, the connection corresponding to the option selected in the selection screen; and
the determination as to whether it is possible to communicate with the image forming apparatus via the router is executed again after the prompting has been executed.

15. The control method according to claim 4, wherein
the determination as to whether it is possible to communicate with the image forming apparatus via the router is executed again after the predetermined processing has been executed.

16. The control method according to claim 15, wherein
based on it being determined again that it is not possible to communicate with the image forming apparatus via the router, processing for transmitting, to the image forming apparatus, setting information for connecting with the router via a connection between the information processing apparatus and the image forming apparatus that does not go through the router is executed.

17. The control method according to claim 1, wherein
the image forming apparatus is an apparatus that executes at least one of printing and scanning.

18. The control method according to claim 1, wherein
the band steering function is a Wi-Fi Agile Multiband function.

19. An information processing apparatus comprising:
one or more memory devices that store a set of instructions; and
one or more processors that execute the set of instructions to:
determining whether it is possible to communicate with an image forming apparatus via a router external to the image forming apparatus and external to the information processing apparatus; and
based on it being determined that it is not possible to communicate with the image forming apparatus via the router, execute predetermined processing for displaying at least one message among: (i) a message for disabling a band steering function in the router, (ii) a message for setting each SSID of a plurality of access points in which used frequency bands are different and which are enabled by the router to a different character string, and (iii) a message for enabling, in a case where the image forming apparatus does not support a first frequency band, a second frequency band different from the first frequency band in the router.

20. A non-transitory computer-readable storage medium, the storage medium storing a program for causing a computer to execute each step of controlling an information processing apparatus, the method comprising:
determining whether it is possible to communicate with an image forming apparatus via a router external to the image forming apparatus and external to the information processing apparatus; and
based on it being determined that it is not possible to communicate with the image forming apparatus via the router, execute predetermined processing for displaying at least one message among: (i) a message for disabling a band steering function in the router, (ii) a message for setting each SSID of a plurality of access points in which used frequency bands are different and which are enabled by the router to a different character string, and (iii) a message for enabling, in a case where the image forming apparatus does not support a first frequency band, a second frequency band different from the first frequency band in the router.
